(19) United States
(12) Patent Application Publication
(10) Pub. No.: US 2023/0408019 A1
(43) Pub. Date: Dec. 21, 2023

(54) Hydraulic Emissions Displacement for Pig Terminals

(71) Applicant: Antero Midstream LLC, Denver, CO (US)

(72) Inventors: Tracy Austin Coppola, Fairmont, WV (US); Jeremy Dayton Jones, Morgantown, WV (US)

(21) Appl. No.: 17/808,018

(22) Filed: Jun. 21, 2022

(51) Int. Cl. F16L 55/46

(52) U.S. Cl. CPC F16L 55/46; F16L 2101/20

(57) ABSTRACT

Using a liquid in a liquid reservoir corresponding to an interior volume of a pig terminal, the pig terminal enabled for fluid communication with a gas pipeline, a first liquid pump enabled for fluid communication with both the liquid reservoir and the pig terminal removes a gas from the interior volume of the pig terminal in response to the first liquid pump causing the gas to be hydraulically displaced from the pig terminal by the liquid from the liquid reservoir, while a recovery line enabled for fluid communication with the pig terminal is enabled to remove the gas from the pig terminal.

### BACKGROUND

### Field of the Disclosure

The present disclosure relates generally to the operation of gas pipelines, and in particular, to capturing emissions from gas pipelines using hydraulic emissions displacement for pig terminals.

### Description of the Related Art

Natural gas pipelines often require frequent inspection to facilitate maintenance of the pipeline. One procedure used to facilitate inspection is running a pipeline inspection gauge, or “pig” through the pipeline. A pig launcher or a pig receiver, collectively referred to herein as a “pig terminal”, can be installed at either end of a section of pipeline to facilitate the entry or removal of the pig. The pig terminal can be isolated from the pressurized environment within the pipeline by an isolation valve through which the pig can pass and which can enable closing or sealing of the pipeline. The pig terminal can be a tubular structure in fluid communication with the isolation valve. The pig terminal typically has a door at an end opposite the isolation valve to facilitate introduction or removal of the pig or both.

As a result of launching or recovering a pig through the pig terminal, an interior volume of the pig terminal will remain pressurized with the pipeline gas after the isolation valve is closed. In typical gas pipeline operations, this pressurized volume of gas can be vented into the atmosphere each time a pigging operation is performed at the pig terminal.

The venting of greenhouse gases (GHG), such as hydrocarbon products carried by such gas pipelines, among other harmful gases, into the atmosphere remains an issue of operational concern that pipeline operators desire to reduce and eliminate. Pipeline operators seek to proactively reduce or eliminate GHG emissions of all kinds in pipeline operations to maintain compliance with present and future regulatory restrictions, as well as to minimize their environmental impact. Such proactive efforts to reduce GHG emissions also serve to maintain a safe working environment for personnel in physical proximity to pipeline operations, such as pigging operations. The reduction or elimination of GHG emissions can also enable pipeline operators to avoid other adverse market effects, such as public relations pressure from various stakeholders ranging from environmental activists to financial institutions that provide access to working capital. Thus, in order to align with ongoing global efforts to reduce GHG emissions into the atmosphere and to maintain an environmentally responsible market presence, venting of GHG into the atmosphere during pipeline operations, such as pigging operations among others, is not desirable.

Furthermore, the installation of large pumps or large compressors to evacuate GHG from the volume of the pig terminal or to pump the GHG back into the pipeline, as conventionally performed, can be uneconomical due to the heavy machinery involved, which can result in relatively large energy consumption, and thus, can undermine any beneficial efforts to reduce GHG emissions. In view of the large number of pig terminals that are used in mid-stream pipelines and the many pigging operations performed at each pig terminal, for example, the reduction of GHG emissions during pigging operations can also significantly improve environmental safety of numerous personnel who can otherwise be exposed to the GHG emissions.

What is needed, therefore, is an improved method and system for launching and recovering pigs in pipelines that significantly reduces or eliminates venting of GHG into the atmosphere. The improved method and system for launching and recovering pigs in pipelines can also satisfy a need to return the pig terminal to atmospheric pressure without operating overly costly pumps or compressors. The improved method and system for launching and recovering pigs in pipelines can also improve the environmental safety conditions for personnel working in proximity to the pig terminal. Embodiments of the present disclosure address these needs as well as other needs that will become apparent upon reading the description below in conjunction with the drawings.

### SUMMARY

In one aspect, an apparatus for hydraulically displacing gas in gas pipelines is disclosed. The apparatus can further include a liquid reservoir enabled to store a liquid and corresponding to an interior volume of a pig terminal, the pig terminal enabled for fluid communication with a gas pipeline. The apparatus can further include a first liquid pump enabled for fluid communication with both the liquid reservoir and the pig terminal, and a recovery line enabled for fluid communication with the pig terminal. In the apparatus, the recovery line can further be enabled to remove a gas from the interior volume of the pig terminal in response to the first liquid pump causing the gas to be hydraulically displaced from the pig terminal by the liquid from the liquid reservoir.

In any of the disclosed implementations of the apparatus, the recovery line can further be enabled for fluid communication with the gas pipeline and enabled to remove the gas into the gas pipeline.

In any of the disclosed implementations of the apparatus, the recovery line can further be enabled for fluid communication with a collection reservoir and enabled to remove the gas into the collection reservoir.

In any of the disclosed implementations, the apparatus can further include a second liquid pump enabled for fluid communication with both the liquid reservoir and the pig terminal and further enabled to remove the liquid from the pig terminal into the liquid reservoir.

In any of the disclosed implementations the apparatus can further include a pressure source enabled for fluid communication with the pig terminal and further enabled to displace the liquid from the pig terminal in response to pressurizing the pig terminal with air.

In any of the disclosed implementations of the apparatus, the pressure source can be an air compressor.

In any of the disclosed implementations of the apparatus, the pressure source can be a second pipeline.

In any of the disclosed implementations the apparatus can further include the pig terminal, while the apparatus can be located on a skid. In any of the disclosed implementations, the apparatus can be located on a vehicle.

In any of the disclosed implementations the apparatus can further include a float actuator enabled for fluid communication with the recovery line, the float actuator further enabled to close the recovery line when the liquid enters the recovery line.

In a further aspect, a method for hydraulic displacement is disclosed. Using a liquid in a liquid reservoir corresponding to an interior volume of a pig terminal, the pig terminal enabled for fluid communication with a gas pipeline, the method can include causing a first liquid pump enabled for fluid communication with both the liquid reservoir and the pig terminal to remove a gas from the interior volume of the pig terminal in response to the first liquid pump causing the gas to be hydraulically displaced from the pig terminal by the liquid from the liquid reservoir. In the method, a recovery line enabled for fluid communication with the pig terminal can be enabled to remove the gas from the pig terminal.

In any of the disclosed implementations of the method, the recovery line can be further enabled for fluid communication with the gas pipeline, while the method can further include removing the gas into the gas pipeline using the recovery line.

In any of the disclosed implementations of the method, the recovery line can be further enabled for fluid communication with a collection reservoir, while the method can further include removing the gas into the collection reservoir using the recovery line.

In any of the disclosed implementations the method can further include, using a second liquid pump enabled for fluid communication with both the liquid reservoir and the pig terminal, removing the liquid from the pig terminal into the liquid reservoir.

In any of the disclosed implementations the method can further include, using a pressure source enabled for fluid communication with the pig terminal, displacing the liquid from the pig terminal in response to pressurizing the pig terminal with air. In any of the disclosed implementations of the method, the pressure source can be an air compressor.

In any of the disclosed implementations of the method, the pressure source can be a second gas pipeline.

In any of the disclosed implementations, the method can further include using a float actuator enabled for fluid communication with the recovery line, the float actuator further enabled to close the recovery line when the liquid enters the recovery line.

In any of the disclosed implementations, the method can further include monitoring a first pressure of the liquid displacing the gas in the pig terminal, monitoring a second pressure of the gas displaced by the liquid, and monitoring a flow rate of the liquid.

In any of the disclosed implementations, the method can further include detecting a leak of the liquid from the pig terminal based on at least one of: the first pressure, the second pressure, and the flow rate.

In still another aspect, a controller for hydraulic displacement is disclosed. The controller can include a processor enabled to access memory media storing instructions executable by the processor, and an input/output communications interface accessible to the processor and enabled to communicate with sensors and actuators included in the system and further enabled to provide a user interface for outputting information to and receiving commands from a user. Using a liquid in a liquid reservoir corresponding to an interior volume of a pig terminal, the pig terminal enabled for fluid communication with a gas pipeline, the instructions can be executable by the processor for causing a first liquid pump enabled for fluid communication with both the liquid reservoir and the pig terminal to remove a gas from the interior volume of the pig terminal in response to the first liquid pump causing the gas to be hydraulically displaced from the pig terminal by the liquid from the liquid reservoir, while a recovery line enabled for fluid communication with the pig terminal can be enabled to remove the gas from the pig terminal.

In any of the disclosed implementations of the controller, the memory media can store first data indicating that the recovery line is further enabled for fluid communication with the gas pipeline, while the gas can be removed into the gas pipeline using the recovery line.

In any of the disclosed implementations of the controller, the memory media can store second data indicating that the recovery line is further enabled for fluid communication with a collection reservoir, while the gas can be removed into the collection reservoir using the recovery line.

In any of the disclosed implementations of the controller, the memory media can further comprise instructions executable by the processor for causing a second liquid pump enabled for fluid communication with both the liquid reservoir and the pig terminal to remove the liquid from the pig terminal into the liquid reservoir.

In any of the disclosed implementations of the controller, the memory media can further comprise instructions executable by the processor for causing a pressure source enabled for fluid communication with the pig terminal to displace the liquid from the pig terminal in response to pressurizing the pig terminal with air.

In any of the disclosed implementations of the controller, the pressure source can be an air compressor. In any of the disclosed implementations of the controller, the pressure source can be a second gas pipeline.

In any of the disclosed implementations of the controller, the memory media can further comprise instructions executable by the processor for causing a float actuator enabled for fluid communication with the recovery line to close the recovery line when the liquid enters the recovery line.

In any of the disclosed implementations of the controller, the memory media can further comprise instructions executable by the processor for at least one of monitoring a first pressure of the liquid displacing the gas in the pig terminal, monitoring a second pressure of the gas displaced by the liquid, and monitoring a flow rate of the liquid.

In any of the disclosed implementations of the controller, the memory media can further comprise instructions executable by the processor for detecting a leak of the liquid from the pig terminal based on at least one of: the first pressure, the second pressure, and the flow rate.

In any of the disclosed implementations of the controller, the memory media can further comprise instructions executable by the processor for at least one of detecting that the pig terminal is isolated from the gas pipeline, detecting that the pig terminal is filled with the gas at the high pressure, detecting whether a pig is present in the pig terminal, outputting a first indication that the pig terminal can be opened, outputting a second indication indicating presence or absence of the pig in the pig terminal, and detecting an over pressure condition associated with the pig terminal.

The foregoing summarizes certain aspects of the presently disclosed subject matter and is not intended to be reflective of the entire scope of the present disclosure. Additional features and advantages of the presently disclosed subject matter are apparent herein, as set forth in the following detailed description and drawings. Moreover, both the foregoing summary and following detailed description and drawings are exemplary and explanatory and are intended to provide further details of the features of the presently disclosed subject matter as claimed.

### BRIEF DESCRIPTION OF THE DRAWINGS

The accompanying drawings, which are incorporated in and constitute a part of this specification, illustrate multiple embodiments of the presently disclosed subject matter and serve to explain the principles of the presently disclosed subject matter. The drawings are not intended to limit the scope of the presently disclosed subject matter in any manner. For a more complete understanding of the present disclosure and its features and advantages, reference is now made to the following description, taken in conjunction with the accompanying drawings.

FIG. 1 depicts a general embodiment of a pig terminal with hydraulic emissions displacement.

FIG. 2A depicts an embodiment of a pig terminal with hydraulic emissions displacement using partially mobile equipment.

FIG. 2B depicts an embodiment of a pig terminal with hydraulic emissions displacement using partially mobile equipment and with external collection.

FIG. 3 depicts an embodiment of a pig terminal with hydraulic emissions displacement using an air compressor.

FIG. 4 depicts an embodiment of a pig terminal with hydraulic emissions displacement using a plunger pump.

FIG. 5 depicts an embodiment of a pig terminal with hydraulic emissions displacement using an external pressure source.

FIG. 6 depicts a plot of a gas pressure profile for hydraulic emissions displacement.

FIG. 7 depicts an embodiment of a controller for hydraulic emissions displacement.

FIG. 8 is a flowchart of a method for hydraulically displacing emissions.

### DETAILED DESCRIPTION

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically or collectively. Thus, as an example (not shown in the drawings), device “12-1” refers to an instance of a device class, which can be referred to collectively as devices “12” and any one of which can be referred to generically as a device “12”. In the figures and the description, like numerals are intended to represent like elements.

Herein, the use of terms such as “having,” “has,” “including,” or “includes” are open-ended and are intended to have the same meaning as terms such as “comprising” or “comprises” and not preclude the presence of other structure, material, or acts. Similarly, though the use of terms such as “can” or “may” are intended to be open-ended and to reflect that structure, material, or acts are not necessary, the failure to use such terms is not intended to reflect that structure, material, or acts are essential. To the extent that structure, material, or acts are presently considered to be essential, they are identified as such.

It is also to be understood that the mention of one or more method steps does not preclude the presence of additional method steps or intervening method steps between those steps expressly identified. Moreover, although the term “step” can be used herein to connote different aspects of methods employed, the term should not be interpreted as implying any particular order among or between various steps herein disclosed unless and except when the order of individual steps is explicitly required.

The components described hereinafter as making up various elements of the subject matter of the present disclosure are intended to be illustrative and not restrictive. Many suitable components that would perform the same or similar functions as the components described herein are intended to be embraced within the scope of the disclosure. Such other components not described herein can include, but are not limited to, for example, similar components that are developed after development of the presently disclosed subject matter.

As noted above, venting of natural gas or methane into the atmosphere as a result of pigging operations is not desirable. Conventional methods of capturing pressurized gas from a pig terminal involve using heavy equipment, such as a large gas compressor, to remove the pressurized gas from the volume of the pig terminal. Such methods can involve expensive heavy equipment that is costly and time-consuming to transport and install, and also consumes a great deal of energy to operate. Further, a pipeline operator can perform thousands of pigging operations at hundreds of locations in the course of normal pipeline operations. Using dedicated conventional heavy equipment, such as a diesel engine powered gas compressor, at each location to capture gas emissions would involve very large capital expenditures and would not be economical due to the relatively small volume of gas captured during each operation.

As will be described in further detail, hydraulic emissions displacement for pig terminals is disclosed. The methods and systems for hydraulic emissions displacement for pig terminals disclosed herein utilize an incompressible fluid, such as an aqueous or alcoholic liquid, to displace the pressurized gas from within the pig terminal. “Incompressible” in this context refers to fluids whose density remains substantially unchanged by pressure, and includes most liquids, such as water. The pressurized gas at pipeline pressure can comprise GHG. By transmitting forces through the incompressible fluid, the methods and systems for hydraulic emissions displacement for pig terminals disclosed herein can employ various sources of compression or force to efficiently displace the pressurized gas with an incompressible fluid with relatively low energy consumption. The methods and systems for hydraulic emissions displacement for pig terminals disclosed herein can enable capture of the pressurized gas back into the pipeline. The methods and systems for hydraulic emissions displacement for pig terminals disclosed herein can enable capture of the pressurized gas into a collection reservoir that is different from the pipeline. In this manner, the methods and systems for hydraulic emissions displacement for pig terminals disclosed herein can enable a reduction or an elimination of GHG emissions associated with at least some pipeline operations, and can also prevent personnel in proximity to pig terminals from being exposed to GHG emissions or other unsafe environmental conditions.

In some embodiments, the methods and systems for hydraulic emissions displacement for pig terminals disclosed herein can use at least some mobile equipment, such as located on a vehicle and transported to the pig terminal. The methods and systems for hydraulic emissions displacement for pig terminals disclosed herein can utilize a power source that is mobile or fixed at a location. The methods and systems for hydraulic emissions displacement for pig terminals disclosed herein can utilize a power source that is provided as a pressurized gas supply. The methods and systems for hydraulic emissions displacement for pig terminals disclosed herein can utilize at least one rotary-action pump, such as a positive displacement pump, to pump liquids. The methods and systems for hydraulic emissions displacement for pig terminals disclosed herein can utilize an air compressor to provide a pressure source. The methods and systems for hydraulic emissions displacement for pig terminals disclosed herein can utilize a pump that is non-rotary action, such as a plunger pump. The methods and systems for hydraulic emissions displacement for pig terminals disclosed herein can further utilize a tank or reservoir to hold the liquid used for the hydraulic emissions displacement.

In various implementations, the methods and systems for hydraulic emissions displacement for pig terminals disclosed herein can incorporate sensors for monitoring pressure and flow rate, and can be enabled to detect over pressure or leak conditions associated with the pig terminal, or can be able to detect normal operation of the hydraulic emissions displacement, such as the absence of leaks, and over pressure or under pressure conditions. Further, the methods and systems for hydraulic emissions displacement for pig terminals disclosed herein can be enabled to record and certify a volume of emissions that have been captured, or that no emissions have been released, such as for regulatory purposes or for public disclosure.

In particular embodiments, the methods and systems for hydraulic emissions displacement for pig terminals disclosed herein can enable fully automatic displacement of emissions from a pig terminal upon arrival or departure of a pig at the pig terminal. In some embodiments, the methods and systems for hydraulic emissions displacement for pig terminals disclosed herein can be enabled to detect the presence or the absence of a pig at the pig terminal and to initiate hydraulic displacement of emissions without further user input. The methods and systems for hydraulic emissions displacement for pig terminals disclosed herein can provide an external indication, such as a display element, that indicates when the pig terminal has been displaced of gas and is in suitable condition for opening to the environment. Various other features and functionality of the methods and systems for hydraulic emissions displacement for pig terminals are also disclosed herein.

Referring now to the drawings, various depictions and implementations of the methods and systems for hydraulic emissions displacement for pig terminals disclosed herein are presented and described in further detail below. The drawings are schematic and are not generally drawn to scale or perspective. It is noted that certain features or elements or functionality described in one drawing or implementation can be used in combination with different implementations shown in different drawings.

In the following description, reference is made to gas pipelines operating at pipeline pressures for the methods and systems for hydraulic emissions displacement for pig terminals. It is noted that the methods and systems for hydraulic emissions displacement for pig terminals disclosed herein are applicable to various sizes of pipelines and pigs operating at various pipeline pressures. For example, the methods and systems for hydraulic emissions displacement for pig terminals disclosed herein can be used with pipelines and pigs corresponding to diameters from about 0.05 m (5 cm or 2 inches) to about 1.07 m (107 cm or 42 inches). Accordingly, the methods and systems for hydraulic emissions displacement for pig terminals disclosed herein can be used with pipeline pressures from about 0.55 MPa (80 psi gage) to about 11.03 MPa (1,600 psi gage). It is noted that the above ranges for diameters and pressures are exemplary and non-limiting, such that the methods and systems for hydraulic emissions displacement for pig terminals disclosed herein can be used with pipelines and pigs of different diameters and pipeline pressures that can be outside these ranges.

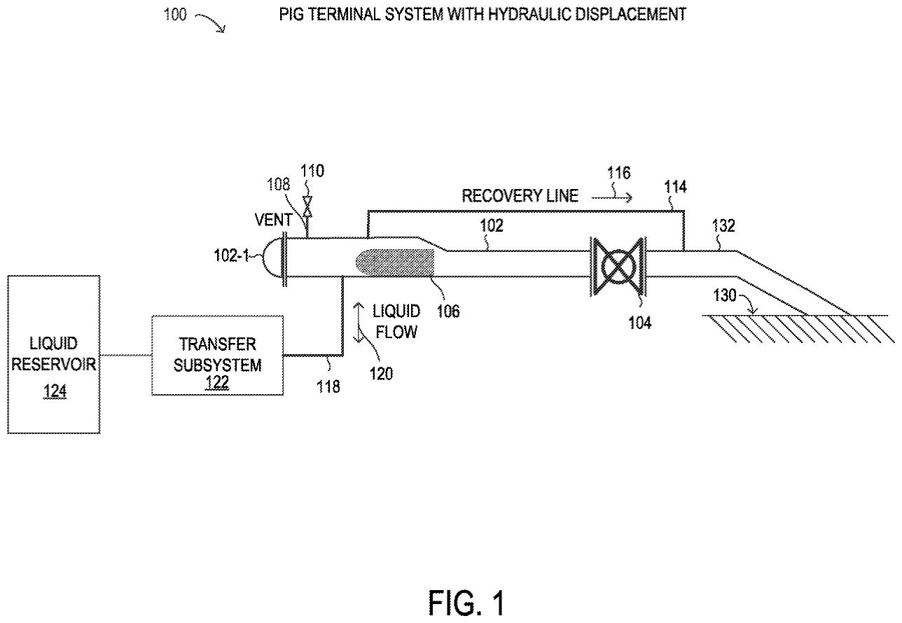

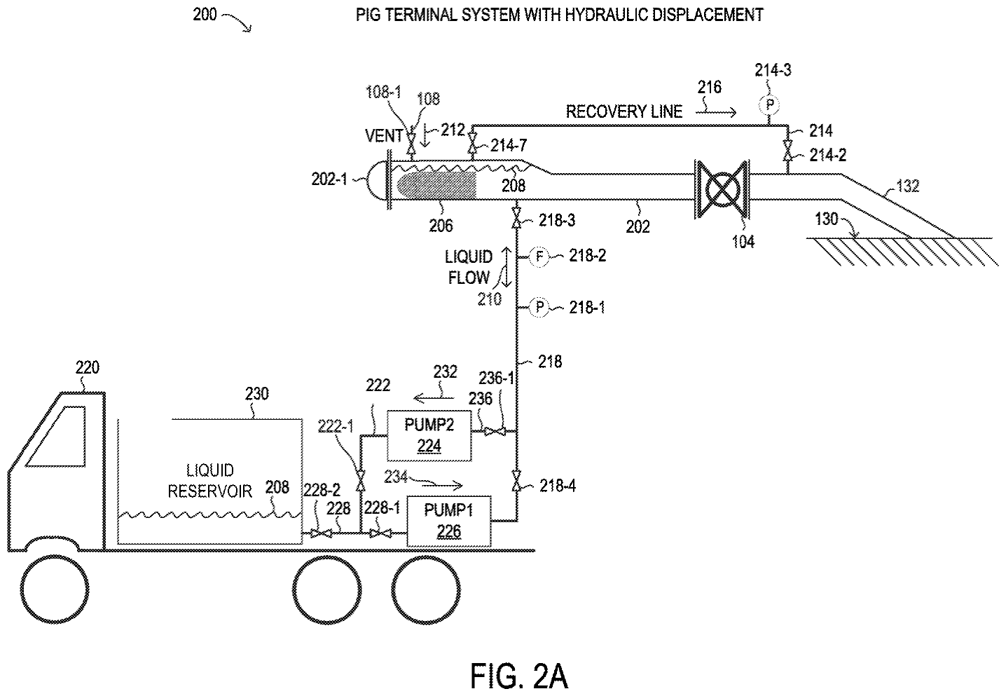

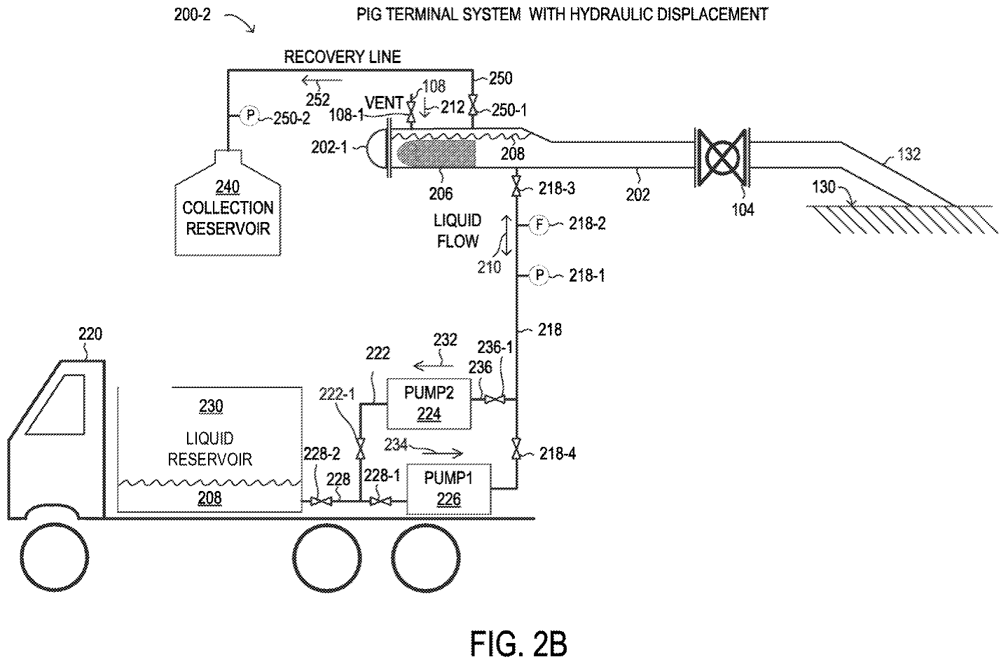

Turning now to FIG. 1, a pig terminal system 100 with hydraulic displacement is depicted. As shown, pig terminal system 100 is a general or generic depiction of elements included in the methods and systems for hydraulic emissions displacement for pig terminals disclosed herein, rather than any single functional depiction. Accordingly, pig terminal system 100, or portions thereof, can represent any particular implementation of the methods and systems for hydraulic emissions displacement for pig terminals disclosed herein, including at least some portions of the specific examples represented in FIGS. 2A, 2B, 3, 4, and 5, as described in further detail below. It is further noted that pig terminal system 100 as depicted in FIG. 1 omits various sub-elements, like seals, valves, control lines, sensors, etc., for descriptive clarity. However, FIG. 1 is intended to schematically represent an operational system with various sub-elements, such as sub-elements also described in the subsequent drawings and corresponding description.

In FIG. 1, pig terminal system 100 is shown comprising a pig terminal 102 that terminates a pipeline 132, shown at a location where pipeline 132 emerges from the ground surface 130, in an exemplary arrangement. It is noted that pig terminal 102 can be associated with various different types of terminal locations or endpoints of pipeline 132 in different arrangements or implementations. As shown in FIG. 1, pipeline 132 is in fluid communication with an isolation valve 104 that is enabled to seal or open pipeline 132 with respect to pig terminal 102 that is in fluid communication with isolation valve 104 at an opposite end. Isolation valve 104 can be a large ball valve with an interior clearance diameter that corresponds to an interior diameter of pipeline 132 and an external diameter of a pig 106, such that pig 106 is enabled to pass through isolation valve 104 when isolation valve 104 is open. Isolation valve 104 can be manually operated, such as by a wheel or a lever that is turned by a human to open or close isolation valve 104, or can be servo-controlled with an servo-mechanical actuator that opens and closes isolation valve 104 in response to a signal or a command. Specifically, isolation valve 104 can be opened to introduce pig 106 into pipeline 132 from pig terminal 102, or can be opened to receive pig 106 from pipeline 132 into pig terminal 102. In FIG. 1, pig 106 is shown schematically as a bullet-shaped device and is oriented corresponding to arrival of pig 106 from pipeline 132. For example, pig 106 faces an exit door 102-1 of pig terminal 102 after isolation valve 104 has been closed and pig terminal 102 has been filled with pipeline gas (not visible) in pipeline 132 at pipeline pressure, after isolation valve 104 was previously opened to allow pig 106 to pass through from pipeline 132. Thus, the depiction of FIG. 1 can correspond to a condition where pig 106 is ready for removal from pig terminal 102 but where pig terminal 102 is filled with a volume of pipeline gas at pipeline pressure. Similarly, after introduction of pig 106 into pig terminal 102, sealing of pig terminal 102, and passing of pig 106 through opened isolation valve 104 (not shown in FIG. 1), isolation valve 104 is closed and pig terminal 102 remains filled with pipeline gas at pipeline pressure.

In conventional operations, a vent valve 110 at a vent line 108 of pig terminal 102 is typically opened to allow the pipeline gas to be vented into the atmosphere and the pipeline pressure in pig terminal 102 to be equilibrated, before exit door 102-1 can be opened. As noted previously, the methods and systems for hydraulic emissions displacement for pig terminals disclosed herein provide an economical alternative to venting of the pipeline gas into the atmosphere in this situation and enable capturing of the pipeline gas, which is desirable for avoiding GHG emissions into the atmosphere, as well as for preventing personnel in proximity to pig terminals from being exposed to harmful gases or environmental conditions.

Specifically, in FIG. 1, pig terminal system 100 includes a liquid reservoir 124 and a transfer subsystem 122 that are together in fluid communication with a liquid line 118 that is further in fluid communication with pig terminal 102 and enables transfer of a liquid (not visible in FIG. 1) to and from pig terminal 102, as shown by liquid flow arrow 120. As noted above, the liquid can be any of various incompressible fluids, such as an aqueous or an alcoholic liquid. In some implementations, the liquid can comprise a glycol or a glycol polymer, such as monoethylene glycol (MEG). It is noted that liquid reservoir 124 and transfer subsystem 122 are shown as generic elements that can represent various types of equipment and liquid line connections, as will be explained in the discussion of the subsequent examples and drawings below. In some embodiments, liquid reservoir 124 and transfer subsystem 122 can be at least partially combined or co-mingled or can be coupled to different inputs and outputs, as will also be explained in the discussion of the subsequent examples and drawings below.

Additionally, in FIG. 1, pig terminal system 100 is depicted including a recovery line 114 that has been installed in fluid communication with pig terminal 102 to enable removal of the pipeline gas through displacement by the liquid being forced or pumped into pig terminal 102. In the depiction shown in FIG. 1, recovery line 114 is in fluid communication with pipeline 132 across isolation valve 104 to enable recovery of the pipeline gas from pig terminal 102 back into pipeline 132 in a direction given by arrow 116, without having to open isolation valve 104. It is noted that other methods or arrangements for recovering the pipeline gas from pig terminal 102 using a recovery line can be practiced in different embodiments (see also FIG. 2B), such as by recovering the pipeline gas into an alternative sink or reservoir.

In operation of pig terminal system 100, when pig terminal 102 is filled with the pipeline gas at pipeline pressure, either with or without pig 106, pig terminal system 100 can be used to hydraulically displace the pipeline gas from pig terminal 102 to recover the pipeline gas. Specifically, liquid reservoir 124 can store a volume of the liquid corresponding to an interior volume of pig terminal 102 when sealed. Transfer subsystem 122 can comprise means for transferring the liquid from liquid reservoir 124 under sufficient pressure through liquid line 118 into pig terminal 102 to displace the pipeline gas at pipeline pressure via recovery line 114, as explained above. After the volume of the liquid has been transferred into pig terminal 102 and the liquid within pig terminal 102 has displaced the pipeline gas, pig terminal 102 is filled with the liquid. Subsequently, vent valve 110 can be opened to draw in atmospheric air while transfer subsystem 122 transfers the liquid from pig terminal 102 back into liquid reservoir 124, leaving pit terminal 102 in a condition of equilibrium with the atmosphere and thus, enabled for opening exit door 102-1. After the liquid has been returned to liquid reservoir 124, pig terminal system 100 returns to a condition where liquid reservoir 124 and transfer subsystem 122 are ready to repeat another emission displacement operation at pig terminal 102.

For the purposes of hydraulic emissions displacement for pig terminals disclosed herein, various different compositions of the liquid can be used. In particular embodiments, an aqueous or alcoholic liquid that is incompressible can be used. The composition or formulation of the liquid can be selected for compatibility with fluid materials, such as hydrocarbon products, flowing through the gas pipeline. For example, the liquid can be formulated to avoid adverse chemical effects when some of the liquid or vapors from the liquid enter pipeline 132. The liquid can be formulated to dissolve and clean residue that can accumulate in pig terminal 102 or on the surface of pig 106. In some instances, the liquid can be used as a means of introducing a desired chemical or mixture into pipeline 132, such as an agent or an additive that is introduced into pipeline 132 for maintenance of pipeline 132. For example, certain additives for the purposes of inhibiting corrosion, inhibiting foaming, or for sterilizing the pipeline (such as by using a biocidal agent) can be used, either alone or in various combinations. In various implementations, the liquid can be stored and reused, at least for a proscribed duration or a given number of emission displacement events, for example, at liquid reservoir 124.

It is noted that pig terminal system 100 can be used and designed in various ways, including mobile, stationary, temporary, and permanent embodiments, or combinations thereof. For example, at least some portions of liquid reservoir 124 and transfer subsystem 122 can be placed on a vehicle and can be driven to the location of pig terminal 102, to perform an emissions displacement operation, whether during introduction or recovery of pig terminal 106. For example, the vehicle can be concurrently used by the operator for pigging and pig management operations. When mobile implementation is used, an energy or power source to perform emissions displacement can be incorporated into the vehicle, such as a mechanical power source or an electrical power source. In some embodiments, at least some portions of liquid reservoir 124 and transfer subsystem 122 can be installed to remain stationary at the location of pig terminal 102, such as by delivery on a skid that can be temporarily or permanently installed and coupled to pig terminal 102. In some embodiments, at least some portions of liquid reservoir 124 and transfer subsystem 122 can be enabled to support emissions displacement on multiple pig terminals 102 that are co-located. For example, a manifold (not shown) at liquid line 118 can be used to select one of a number of pig terminals 102 for emissions displacement, or to cycle through a plurality of pig terminals 102 for successive emissions displacement using some common equipment. In some implementations, at least some portions of liquid reservoir 124 and transfer subsystem 122 can be enabled for concurrent emissions displacement operation with multiple pig terminals 102 (not shown). In this manner, an economical or a desired type of implementation of the methods and systems for hydraulic emissions displacement for pig terminals can be used in various pipeline environments.

As shown in FIG. 1, pig terminal system 100 can be manually operated from the steps of installation, performing of the emissions displacement operation, to the steps of uninstallation, at a given location of pig terminal 102. However, in other implementations, at least some portions of pig terminal system 100 can be configured for automated or unattended operation. For example, pig terminal system 100 can be equipped with any of a variety of sensors to detect any of flow rate, pressure, and liquid level, for example, along with measurement and control equipment to acquire and interpret measurement and signals related to the condition of pig terminal system 100. In this manner, pig terminal system 100 can be able to detect various conditions or states that occur during the emissions displacement process, and to make a determination whether operation is in a normal condition or not. For example, pig terminal system 100 can be able to detect when the emissions displacement process is functioning normally or safely and to generate an output, such as a display indicator, indicative of the normal condition. Additionally, pig terminal system 100 can be enabled to detect a failure condition or an anomaly condition and generate a corresponding output or take a predefined action, such as termination of an emissions displacement operation. For example, one condition for desired completion of the emissions displacement operation is that pig terminal 102 remain sealed to the atmosphere and sealed to pipeline 132. With various sensors to detect pressure and flow rate, as will be described in further detail below, pig terminal system 100 can be able to detect conditions for desired operation and, in this manner, can further be able to record or certify that an amount of gas emissions was prevented from escaping into the atmosphere. Such validation capabilities are another advantage to operators of pig terminal system 100.

In another aspect of pig terminal system 100, automatic operation of the hydraulic emissions displacement operation can be enabled. Given the sensors to detect pressure and flow rate within pig terminal system 100, additional sensors to detect the location of pig 106 relative to pig terminal system 100 can be used. For example, pig terminal system 100 can communicate with a pig communication system (not shown) that can communicate with a controller in pig 106 to provide location information for pig 106. In another example, pig terminal system 100 can use sensors (not shown) to detect proximity to pig 106, thereby giving the location of pig 106 when the location of the sensors is known. Pig terminal system 100 can further detect operation and state information for isolation valve 104, for example, in a similar manner.

Thus, based on detection of the location of pig 106, such as within pig terminal 102 or within pipeline 132, as well as state information for isolation valve 104, pig terminal system 100 can be enabled to automatically detect initiation conditions for the hydraulic emission displacement operation, and further to initiate a hydraulic emission displacement operation without additional user input, in some embodiments. For example, when pig terminal system 100 detects that pig 106 has been launched into pipeline 132, isolation valve 104 is closed, and pig terminal 102 is pressurized with gas at pipeline pressure, pig terminal system 100 can initiate a hydraulic emission displacement operation, as disclosed herein. In a further example, when pig terminal system 100 detects that pig 106 has arrived from pipeline 132 into pig terminal 102, isolation valve 104 is closed, and pig terminal 102 is pressurized with gas at pipeline pressure, pig terminal system 100 can initiate a hydraulic emission displacement operation, as disclosed herein.

Referring now to FIG. 2A, a pig terminal system 200-1 is shown enabled for hydraulic emission displacement operations, as disclosed herein. Pig terminal system 200-1 depicts an implementation of pig terminal system 100 with specific equipment that is at least partially mobile and can be transported to a location of pipeline 132 emerging from the ground 130 and having isolation valve 104 in fluid communication. As shown in FIG. 2A, pig terminal system 200-1 comprises a pig terminal 202 that is similar to pig terminal 102 (see FIG. 1). However, in pig terminal system 200-1, pig terminal 202 is shown in a condition during the hydraulic emission displacement operation. Specifically, pig terminal 202 is shown filled with a liquid 208 used to displace the gas (not visible) after a pig 206 has arrived at pig terminal 202 and isolation valve 104 has closed, as will be explained in further detail.

As shown in FIG. 2A, pig terminal 202 is substantially similar to pig terminal 102 described previously with respect to FIG. 1. Pig terminal 202 is shown coupled to pipeline 132 via a recovery line 214 that is installed and that enables a volume of gas from pig terminal 202 to be forced back into pipeline 132 across isolation valve 104, in a direction shown by arrow 216. As shown in FIG. 2A, recovery line 214 is also equipped with a gas pressure sensor 214-3, a first valve 214-1 and a second valve 214-2 in fluid communication. Thus, not only do first valve 214-1 and second valve 214-2 enable control of the gas flowing through recovery line 214, the valves enable measurement of pressure by gas pressure sensor 214-3 at pig terminal 202, at recovery line 214, and at pipeline 132. Also visible at pig terminal 202 is a vent line 108 with a vent valve 108-1 that can be used, for example, to draw in ambient air into pig terminal 202, in a direction given by arrow 212.

Also as shown in FIG. 2A, a first liquid line 218 is in fluid communication with pig terminal 202 and coupled to pig terminal 202 where a third valve 218-3 is in fluid communication. Also in fluid communication with first liquid line 218 are a fluid pressure sensor 218-1 and a flow rate meter 218-2, which are enabled to measure liquid pressure and liquid flow rate, respectively. In operation, liquid 208 can flow in either direction given by arrows 210 through first liquid line 218, as will be explained below. First liquid line 218 is also in fluid communication with a fourth valve 218-4 where first liquid line is in fluid communication with a first pump 226 that is enabled to force liquid 208 in a direction given by arrow 234 towards pig launcher 202. A second liquid line 228 is in fluid communication with first pump 226 and a liquid reservoir 230 where liquid 208 can be stored. It is noted that liquid reservoir 230 can store at least a volume of liquid 208 corresponding to a volume of pig terminal 202. A fifth valve 228-1 and a sixth valve 228-2 are in fluid communication with second liquid line 228, along with a third liquid line 222. Third liquid line 222 is in fluid communication with a seventh valve 222-1 and a second pump 224 that is enabled to force liquid 208 in a direction given by arrow 232 towards liquid reservoir 230. First liquid line 218 and second pump 224 are in fluid communication with a fourth liquid line 236 and an eighth valve 236-1.

In FIG. 2A, liquid reservoir 230 storing liquid 208, as well as first pump 226 and second pump 224, are located on a vehicle 220, such as a truck with a bed, along with the corresponding liquid lines and valves as shown and described. Vehicle 220 can be used to transport certain portions of pig terminal system 200-1 to pig terminal 202, along with other materials, such as pig 206 or materials and equipment related to the pigging operation, which is not further described here. For example, vehicle 220 can be driven to the location of pig terminal 202 and installed at pig terminal 202 as shown to enable a hydraulic emission displacement operation.

In operation of pig terminal system 200-1, pig terminal 202 can reach a condition where pig terminal 202 is filled with gas at pipeline pressure, such as after pig 206 has arrived from pipeline 132 and has passed through isolation valve 104, before isolation valve 104 is closed and an exit door 202-1 remains sealed. In another condition of pig terminal system 200-1 (not shown), pig 206 can be introduced into pipeline 132 after which isolation valve 104 is closed, such that pig terminal 202 is vacant yet filled with gas at pipeline pressure. When either of these conditions are met, a hydraulic emission displacement operation can be initiated, either automatically as described above, or manually by an operator.

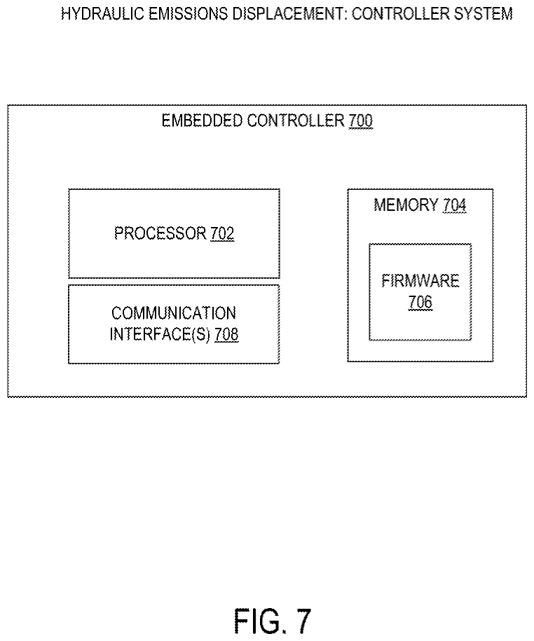

As noted above, pressure sensors 214-3, 218-1 and flow rate sensor 218-2 can be used to detect various conditions of pig terminal system 200. For example, when a leak is present at pig terminal 200, at least one of pressure sensors 214-3, 218-1 and flow rate sensor 218-2 can provide measurements or signals that indicate a leak in pig terminal 200. Similarly, different conditions, such as abnormal or alarm conditions or normal conditions, can be detected using one or more of the sensors used with pig terminal system 200, including at least one of: detecting that the pig terminal is isolated from the gas pipeline, detecting that the pig terminal is filled with gas at pipeline pressure, detecting whether a pig is present in the pig terminal, and detecting an over pressure condition associated with the pig terminal. The results of such detected conditions can be output as an indication for an operator, such as by embedded controller 700 (see FIG. 7). Other indications that can be output to the operator of pig terminal system 200 include at least one of: a first indication that the pig terminal can be opened, and a second indication indicating presence or absence of the pig in the pig terminal.

In pig terminal system 200-1, upon initiation of the hydraulic emission displacement operation, liquid reservoir 230 is filled with liquid 208. Then, seventh valve 222-1 can be closed, along with eighth valve 236-1 in order to isolate second pump 224. Next, third valve 218-3, fourth valve 218-4, fifth valve 228-1 and sixth valve 228-2 can be opened to create a pumping line for first pump 226 in fluid communication with pig terminal 202. It is noted that any air in first liquid line 218 can be bled out before third valve 218-3 is opened, such that first liquid line 218 is primed with liquid 208 before exposure to the gas at pipeline pressure. Then, about when third valve 218-3 is opened and first pump 226 begins operating, first valve 214-1 and second valve 214-2 are opened. As first pump 226 starts forcing liquid 208 into pig terminal 202, first pump 226 overcomes the pipeline pressure and forces liquid 208 into pig terminal 202 in direction 234, while the gas at pipeline pressure is forced through recovery line 214 in direction 216 though displacement by liquid 208. As shown, pig 206 is within pig terminal 202 and is immersed by liquid 208.

In pig terminal system 200, as liquid 208 fills pig terminal 202, first pump 226 can stop operation when pig terminal 202 is filled or substantially filled with liquid 208, as shown. First pump 226 can be stopped using various means. For example, an output signal from flow meter 218-2 can be converted into cumulative volume and can be used to stop first pump 226 based on a desired volume to displace the interior volume of pig terminal 202. In another example, a float valve (not shown) or similar type of liquid check valve can be used to generate a stop signal for first pump 226 when liquid 208 fills pig terminal 202. In some implementations, liquid 208 can be detected at first valve 214-1 upon entering recovery line 214 to generate a signal to stop first pump 226, such as by including a float actuator (not shown) with first valve 214-1 that is enabled to close first valve 214-1 as soon as liquid 208 enters recovery line 214. When liquid 208 fills pig terminal 202, the hydraulic displacement of the gas at pipeline pressure is achieved and the gas has been forced back into pipeline 132.

In pig terminal system 200, after hydraulic displacement is completed, pig terminal system 200 can be reconfigured to pump liquid 208 back into liquid reservoir 230. Specifically, fourth valve 218-4 and fifth valve 228-1 can be closed to isolate first pump 226, while seventh valve 222-1 and eighth valve 236-1 are opened to place second pump 224 in fluid communication with first liquid line 214. Then, vent valve 108-1 is opened while second pump 232 begins pumping liquid 208 back into liquid reservoir 230 in direction 232, such that vent valve 108-1 draws in ambient air into pig launcher 202. Second pump 224 is so operated until pig terminal 202 is drained of liquid 208.

Then, in the example shown in FIG. 2A, third valve 218-3 and vent valve 108-1 can be closed. When pig terminal system 200-1 is housed on vehicle 220, at least some portion of first liquid line 214 can be detached from pig terminal 202 and stowed on vehicle 220, for example. Then, the hydraulic emission displacement operation is complete, and exit door 202-1 can be opened to remove pig 206 from pig terminal 202, while the remaining valves can be closed, as liquid 208 again fills liquid reservoir 230.

Referring now to FIG. 2B, a pig terminal system 200-2 is shown enabled for hydraulic emission displacement operations, as disclosed herein. Pig terminal system 200-2 depicts an implementation of pig terminal system 200-1 but without recovery line 214 that feeds the gas at pipeline pressure back into pipeline 132. Instead, pig terminal system 200-2 comprises a recovery line 250 in fluid communication with a collection reservoir 240. Collection reservoir 240 can comprised any pressurized container enabled to receive and store the gas at pipeline pressure from pig terminal 202. Accordingly, in pig terminal system 200-2, the hydraulic emission displacement operation is performed with a recovery valve 250-1 and a pressure sensor 250-2 in fluid communication where the gas at pipeline pressure from pig terminal 202 is forced through recovery line 250 in a direction given by arrow 252 for collection in collection reservoir 240. In some embodiments, collection reservoir 240 can be enabled to collect gas from a plurality of pig terminals (not shown) for subsequent transfer or use. Various other aspects of pig terminal system 200-2 are shown substantially similar to pig terminal system 200-1 (see FIG. 1).

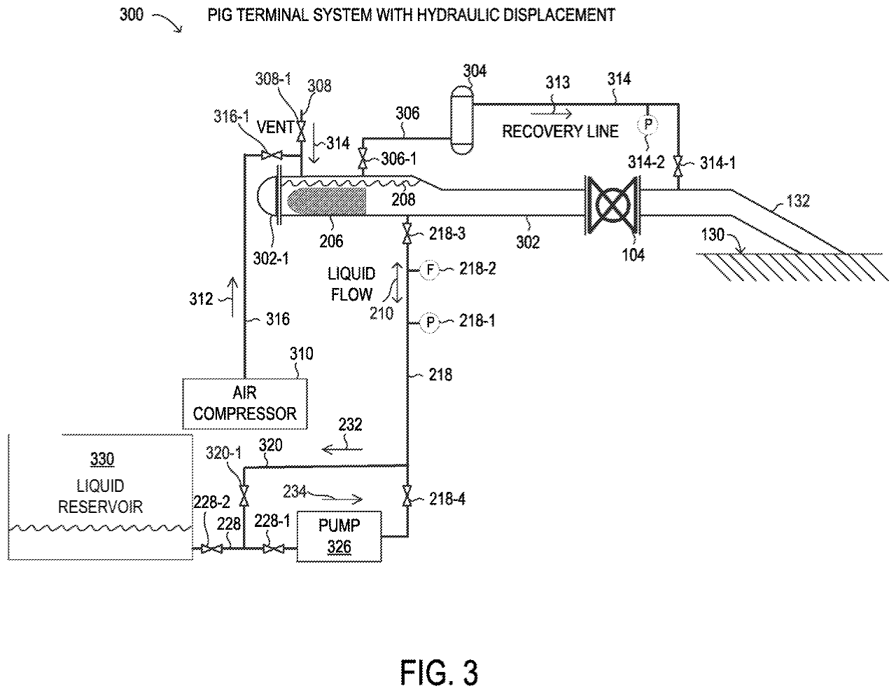

Referring now to FIG. 3, a pig terminal system 300 is shown enabled for hydraulic emission displacement operations, as disclosed herein. Pig terminal system 300 depicts an implementation of pig terminal system 100 with specific equipment that is stationary at a location of pipeline 132 emerging from the ground 130 and having isolation valve 104 in fluid communication. Although pig terminal system 300 is depicted as stationary, it is noted that certain portions of pig terminal system 300 can be installed on a vehicle, similar to pig terminal system 200-1 (see FIG. 2A). As shown in FIG. 3, pig terminal system 300 comprises a pig terminal 302 that is similar to pig terminal 202 (see FIG. 2A). Specifically, pig terminal 302 is shown filled with a liquid 208 used to displace the gas (not visible) after a pig 206 has arrived at pig terminal 302 and isolation valve 104 has closed, as will be explained in further detail.

As shown in FIG. 3, pig terminal 302 is substantially similar to pig terminal 202 described previously with respect to FIG. 2A, and includes an exit door 302-1. However, instead of recovery line 214 that directly feeds the gas (not shown) back into pipeline 132 as in FIG. 2A, pig terminal 302 in FIG. 3 includes a first recovery line 306 in fluid communication with a liquid trap 304 and a second valve 306-1 also in fluid communication. As shown, liquid trap 304 can be a canister that enables liquid to be retained and accumulate at a lower portion, where the accumulated liquid can be drained, such as by a drain line (not shown), while gas can pass through liquid trap 304 and exit at a second recovery line 314 in fluid communication in a direction given by arrow 313. Accordingly, first recovery line 306, liquid trap 304, and second recovery line 314 can enable a volume of gas from pig terminal 302 to be forced back into pipeline 132 across isolation valve 104, in a direction shown by arrow 318. As shown in FIG. 3, second recovery line 314 is also equipped with a gas pressure sensor 314-2 and a first valve 314-1, while first recovery line 306 is equipped with second valve 306-1 in fluid communication.

Also visible in FIG. 3 at pig terminal 302 is a vent line 308 with a vent valve 308-1 that can be used, for example, to draw in ambient air into pig terminal 302, in a direction given by arrow 314. Thus, vent line 308 can operate in a substantially similar manner as vent valve 108 shown in the previous figures. However, vent line 308 in pig terminal system 300 is in fluid communication with a forced air line 316 equipped with forced air valve 316-1 in fluid communication. Forced air line 316, as shown, is supplied by an air compressor 310 that can be dimensioned to supply about 690 to 11,000 kPa (100 to 1,600 psi) of air pressure from ambient air in a direction given by arrow 312, in various implementations. It is noted that this pressure range is exemplary and that various other pressure ranges can be applied in different implementations. Accordingly, air compressor 310 can be used to supply back pressure to force out liquid 208 from pig terminal 302, after pig terminal 302 has been filled with liquid 208 that has displaced the gas at pipeline pressure that filled pig terminal 302 with the arrival of pig 206. For example, as compared with pig terminal system 200-1 in FIG. 2A, pig terminal system 300 in FIG. 3 can operate with air compressor 310 instead of second pump 224 to force liquid 208 back into liquid reservoir 330 in direction 232. Specifically, when air compressor 310 is used, vent valve 308-1 can be closed, while forced air valve 316-1 can be opened to allow compressed air to enter pig terminal 302 and force out liquid 208. Thus, pig terminal system 300 can use third liquid line 320 in fluid communication with first liquid line 218 and second liquid line 228, as shown. Third liquid line 320 is shown in fluid communication with seventh valve 320-1, while in pig terminal system 300 eighth valve 236-1 is not included. In this manner, in pig terminal system 300, a first liquid pump 326 is used alone without a second liquid pump, which can save cost and maintenance as compared to using air compressor 310. It is noted that the arrangement using air compressor 310 instead of second pump 224 can be used in various embodiments, such as other implementations in various figures described herein.

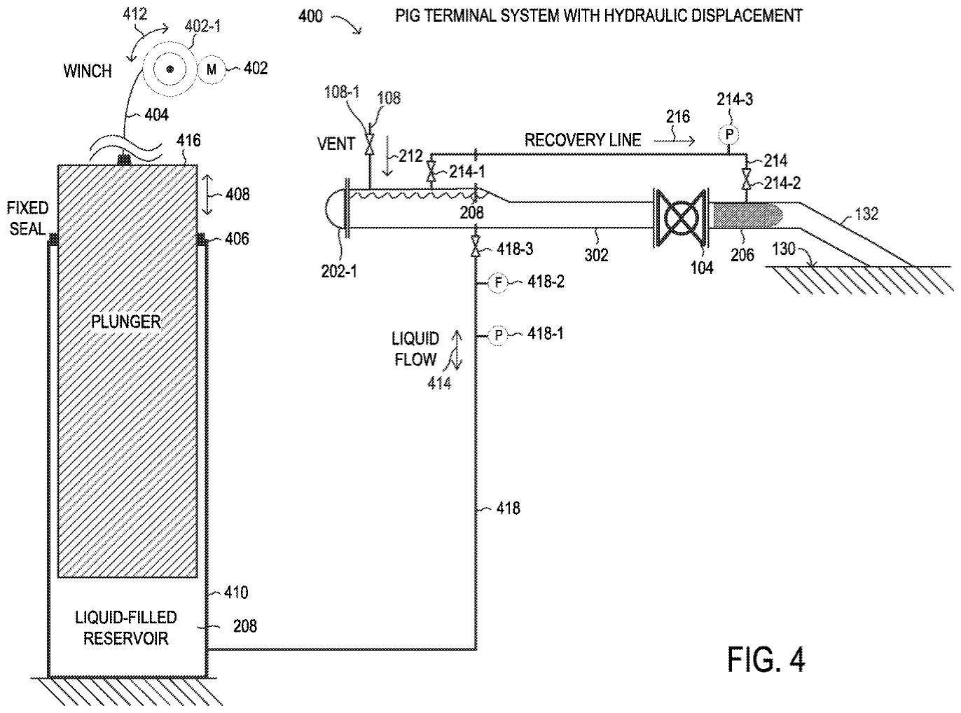

Referring now to FIG. 4, a pig terminal system 400 is shown enabled for hydraulic emission displacement operations, as disclosed herein. Pig terminal system 400 depicts an implementation of pig terminal system 100 with specific equipment that is stationary at a location of pipeline 132 emerging from the ground 130 and having isolation valve 104 in fluid communication. Although pig terminal system 400 is depicted as stationary, it is noted that certain portions of pig terminal system 400 can be installed on a vehicle for mobile use, as described previously. In particular implementations, at least some portions of pig terminal system 400 (or other pig terminal systems disclosed herein) can be pre-assembled on a skid and can be delivered for use, such as to facilitate ease of connection on-site, for example. As shown in FIG. 4, pig terminal system 400 comprises pig terminal 202 and associated elements that are substantially similar to pig terminal 202 in FIG. 2A and are numbered identically. Furthermore, it is noted that pig terminal system 400 can be used in various configurations, such as by incorporating air compressor 310 and associated elements or by incorporating liquid trap 304 and associated elements as described above (see FIG. 3).

In FIG. 4, pig terminal 202 is depicted in a condition after pig 206 has been introduced into pipeline 132 via isolation valve 104, and after isolation valve 104 has closed behind pig 206. Furthermore, pig terminal 202 is shown filled with liquid 208 after hydraulic displacement of the gas at pipeline pressure that was present in pig terminal 202 as isolation valve was closed behind pig 206. Thus, pig terminal 202 is depicted in a condition where hydraulic emissions displacement is performed after launching of pig 206 into pipeline 132.

As shown, pig terminal system 400 includes a non-rotary pumping system that has few moving parts that are suitable for reliable outdoor operation. Furthermore, pig terminal system 400 can be a particularly economic system for stationary or fixed installation use, while the non-rotary pumping system can be usable with a plurality of pig terminals (not shown) at a given location, such as by using a liquid manifold to select from one of a number of different liquid lines that each go to respective separate pig terminals (not shown). Furthermore, the non-rotary pumping system can be easily dimensioned for use with various sizes and pressures of pipeline 132 and accordingly, various sizes of pig 206, and various sizes of pig terminal 202.

In FIG. 4, a liquid line 418 is in fluid communication with pig terminal 202 in order to facilitate filling and emptying of pig terminal 202 by liquid 208 corresponding to a liquid flow in liquid line 418 as indicated by a bidirectional arrow 414. Liquid line 418 is in fluid communication with a liquid-filled reservoir 410 that is filled with liquid 208 and is evacuated from air. Liquid-filled reservoir 410 has an opening at a top end that engages with a plunger 416 that runs into and out of liquid-filled reservoir 410 by means of a fixed seal 406 installed at the top edge, corresponding to a plunger pump-type arrangement. As plunger 416 runs downwards into liquid-filled reservoir 410, the volume within liquid-filled reservoir 410 is reduced and liquid 208 is forced out via liquid line 418. As plunger 416 withdraws upwards from liquid-filled reservoir 410, the volume within liquid-filled reservoir 410 increases, thereby drawing in liquid 208 via liquid line 418. The vertical motion of plunger 416, as indicated by bidirectional arrow 408, can be enabled using a winch motor 402, such as by means of a cable 404 that is wound around a spool 402-1 that is turned by winch motor 402 and that can rotate as indicated by bidirectional arrow 412. By virtue of the vertical arrangement and a weight of plunger 416, the downward pumping stroke to force liquid 208 into liquid line 418 can be performed with little or no energy consumption. However, the upward pumping stroke of plunger 416 can involve lifting the weight of plunger 416 along with the weight of liquid 208 drawn into liquid-filled reservoir 410 in this manner, which can be performed by winch motor 402.

As shown in FIG. 4, liquid-filled reservoir 410 can be formed as a tank, such as a cylindrically-shaped steel vessel, while plunger 416 can also be a cylindrically-shaped body made out of a sufficiently heavy material to provide pumping force to displace the gas at pipeline pressure from pig terminal 202 using liquid 208. Furthermore, liquid-filled reservoir 410 and plunger 416 can be sized to displace a desired volume of pig terminal 202, whereby a height or a radius or both of such cylindrical dimensions can be varied in different embodiments. Because plunger 416 does not contact liquid-filled reservoir 410 other than at fixed seal 406, plunger 416 can be formed with greater dimensional tolerances and can accordingly less expensive than a piston that mates with a cylinder. Plunger 416 can be made using a heavy material such as concrete or steel or combinations thereof. In some embodiments, plunger 416 itself can comprise a liquid tank (not shown) that is filled with a heavy liquid, such as water or oil, in order to match a weight of plunger 416 with a desired pressure of liquid 208, for example, while maintaining a constant volume of plunger 416. As noted, due to their cylindrical shape, liquid-filled reservoir 410 and plunger 416 can be easily dimensioned for use with various sizes of pipeline 132, pig 206, pig terminal 202, under various pipeline pressures.

As shown in FIG. 4, liquid line 418 is in fluid communication with pig terminal 202 and coupled to pig terminal 202 where a third valve 418-3 is in fluid communication. Also in fluid communication with liquid line 418 are a fluid pressure sensor 418-1 and a flow rate meter 418-2, which are enabled to measure liquid pressure and liquid flow rate, respectively. In operation, liquid 208 can flow in either direction given by arrows 414 through liquid line 418 as plunger 416 is raised or lowered, in order to perform the hydraulic displacement of the gas within pig terminal 202, as explained in detail above. It is noted that various dimensions of pig terminal system 400 can be varied to achieve various ranges of performance, such as a weight of plunger 416 and diameter of liquid line 418 to control pumping force and pumping flow rate of the liquid 208, for example.

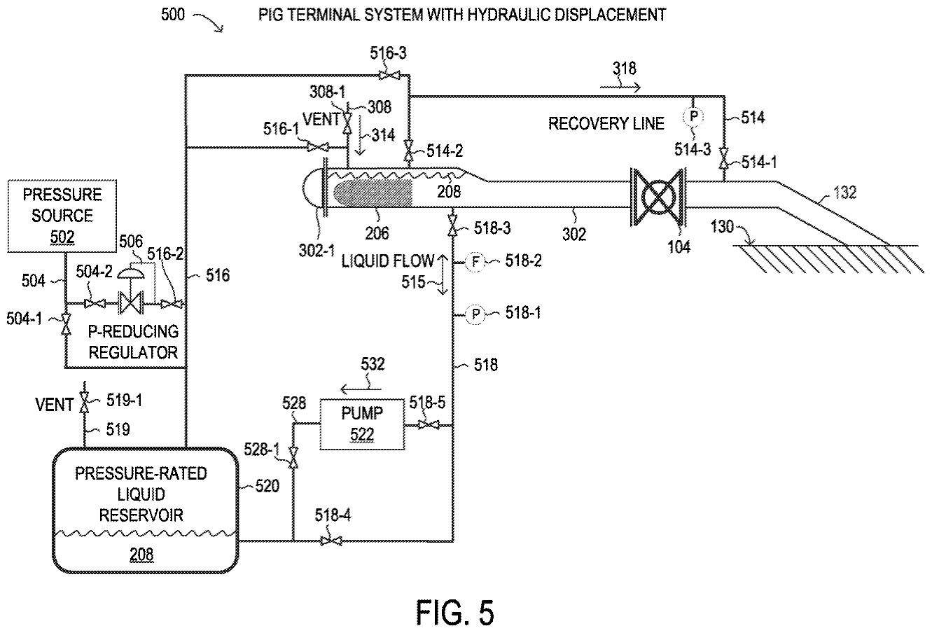

Referring now to FIG. 5, a pig terminal system 500 is shown enabled for hydraulic emission displacement operations, as disclosed herein. Pig terminal system 500 depicts an implementation of pig terminal system 100 with specific equipment that is stationary at a location of pipeline 132 emerging from the ground 130 and having isolation valve 104 in fluid communication. Although pig terminal system 500 is depicted as stationary, it is noted that certain portions of pig terminal system 500 can be installed on a vehicle for mobile use, as described previously. Furthermore, it is noted that pig terminal system 500 can be used in various configurations, such as by incorporating various elements as described previously.

As shown in FIG. 5, pig terminal system 500 comprises pig terminal 302 and associated elements that are substantially similar to pig terminal 302 in FIG. 3 and are numbered identically. Pig terminal system 500 also comprises a liquid line 518 and associated elements that are similar to liquid line 418 in FIG. 4. As shown in FIG. 5, liquid line 518 is in fluid communication with pig terminal 302 and coupled to pig terminal 302 where a third valve 518-3 is in fluid communication. Also in fluid communication with liquid line 518 are a fluid pressure sensor 518-1 and a flow rate meter 518-2, which are enabled to measure liquid pressure and liquid flow rate, respectively. In operation, liquid 208 can flow in either direction given by arrows 515 through liquid line 518 in operation of pig terminal system 500 as described in further detail below. Liquid line 518 is also in fluid communication with a pump 522 via a fifth valve 518-5, while pump 522 is enabled to pump liquid 206 in a direction 532 back into liquid reservoir 520. Accordingly, pump 522 is in fluid communication with a second liquid line 528 in fluid communication with a sixth valve 528-1 that loops back in fluid communication with fluid line 518, as shown. Additionally, liquid line 518 has a fourth valve 518-4 to control flow of liquid 208.

As shown in FIG. 5, pig terminal system 500 uses a pressure source 502 as a primary energy source for liquid displacement of the gas at pipeline pressure from pig terminal 302. For example, pressure source 502 can be another pipeline or another piece of equipment that is already available to provide a source of pressure, such as a pressurized gas. The pressurized gas provided by pressure source 502 can be an inert gas or air in some embodiments. When pressure source 502 is a gas pipeline, pig terminal system 500 can displace gas at a first pressure from pig terminal 302 that is higher than a second pressure used for hydraulic displacement, which can lower emissions of the gas. Alternatively, pig terminal system 500 can utilize pump 522 to displace gas from a liquid reservoir 520 to eliminate emissions, as will be explained below.

As shown in FIG. 5, liquid line 518 is in fluid communication with liquid reservoir 520 that can be sealed and certified for a certain pressure to function as a pressure vessel, such as by pressure testing to a certified pressure. Liquid reservoir 520 is in fluid communication with a second vent line 519 equipped with a second vent valve 519-1 to enable selective venting of any pressurized gas, as desired. Liquid reservoir 520 is also in fluid communication with a first pressure line 516 that is in fluid communication with vent line 308 via a first pressure valve 516-1. First pressure line 516 is also in fluid communication with a return line 514 via a third pressure valve 516-3. First pressure line 516 is in fluid communication with an output of a pressure regulator 506, shown as a pressure reducing regulator, via a second pressure valve 516-2. Pressure regulator 506 is in fluid communication with a second pressure line 504 via a fifth pressure valve 504-2 that is in fluid communication with pressure source 502 to provide high pressure gas to an input of pressure regulator 506. Second pressure line 504 is also in fluid communication with first pressure line and liquid reservoir 520 via a fourth pressure valve 504-1.

As shown in FIG. 5, a recovery line 514 directly feeds the gas (not shown) back into pipeline 132. Accordingly, recovery line 514 can enable a volume of gas from pig terminal 302 to be forced back into pipeline 132 across isolation valve 104, in a direction shown by arrow 318. As shown in FIG. 5, recovery line 514 is also equipped with a gas pressure sensor 514-3, a first valve 514-1 in fluid communication with pipeline 132, and a second valve 514-2 in fluid communication with pig terminal 302.

In operation of pig terminal system 500, pressure source 502 provides a relatively high pressure source that is greater than a first displacement pressure for forcing liquid 208 into pig terminal 302 when pig terminal 302 is pressurized at pipeline pressure. The high pressure from pressure source 502 is reduced to the first displacement pressure by pressure regulator 506. Then, when pig terminal 302 is filled with gas at pipeline pressure of gas pipeline 132, such as after arrival of pig 206 at pig terminal 302, and liquid reservoir 520 is filled with liquid 208, vent valve 308-1, second vent valve 519-1, fourth pressure valve 504-1, fifth valve 518-5, sixth valve 528-1, first pressure valve 516-1, and third pressure valve 516-3 are closed, while fifth pressure valve 504-2, second pressure valve 516-2 and fourth valve 518-4 are opened, thereby enabling the first displacement pressure to push liquid 208 out of liquid reservoir 512 into liquid line 518. At recovery line 514, first valve 514-1 and second valve 514-2 are opened to enable the gas at pipeline pressure in pig terminal 302 to be forced back into pipeline 132. Then, third valve 518-3 is opened, enabling the first displacement pressure to force liquid 208 from liquid reservoir 520 into pig terminal 302. As liquid 208 fills pig terminal 302, corresponding to the condition depicted in FIG. 5, the gas at pipeline pressure within pig terminal 302 is forced back into pipeline 132.

After pig terminal 302 is filled with liquid 208, in pig terminal system 500, it is noted that, for example, second valve 514-2 can include a float actuator that closes second valve 514-2 when a level of liquid 208 reaches second valve 514-2, in a condition where pig terminal 302 is fully filled with liquid 208. Then, first valve 514-1 and second pressure valve 516-2 are closed. Next, to remove liquid 208 from pig terminal 302, pump 522 can be used to pump liquid 208 back into liquid reservoir 520, while vent valve 308-1 can be opened to draw in ambient air into pig terminal 302. To accomplish the reverse pumping of liquid 208 by pump 522, vent valve 308-1, fifth valve 518-5, and sixth valve 528-1 are opened, while fourth valve 518-4 is closed. Because in this state, liquid reservoir 520 is filled with gas at the first displacement pressure, pig terminal system 500 can enable the gas from liquid reservoir 520 to be forced back either into pressure source 502 or back into pipeline 132. In the first case, to pump the gas from liquid reservoir 520 back into pressure source 502, second pressure valve 516-2 and fifth pressure valve 504-2 are closed, while fourth pressure valve 504-1 is opened, and pump 522 can be started. In the second case, to pump the gas from liquid reservoir 520 back into pipeline 132, second pressure valve 516-2, fourth pressure valve 504-1, first pressure valve 516-1, and second valve 514-2 are closed, while third pressure valve 516-3 and first valve 514-1 are opened, and pump 522 can be started. In this manner, pig terminal system 500 can be used to prevent any emissions into the atmosphere.

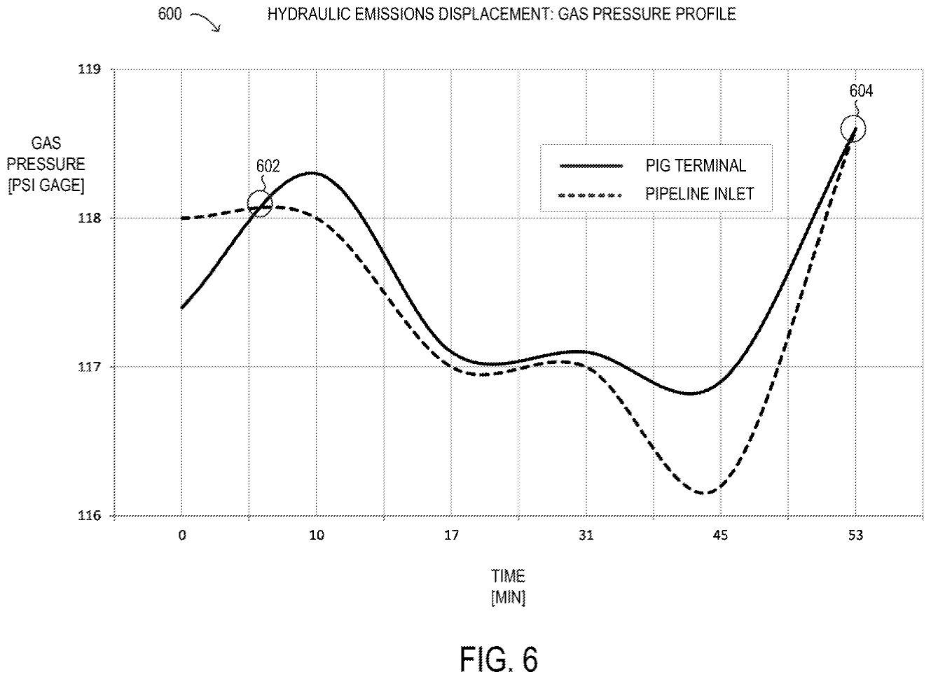

Turning now to FIG. 6, a gas pressure profile 600 is depicted as a dual plot of gas pressure in psi gage versus time in minutes. Gas pressure profile 600 is applicable to pig displacement systems having a recovery line that feeds back into pipeline 132 (see FIGS. 1, 2A, 3, 4, and 5). In gas pressure profile 600, a first plot in solid line shows measured data for pressure within the pig terminal, while a second plot in dashed line shows measured data for pressure at the pipeline inlet, such as at second valve 314-1 (see FIGS. 3, 5), for example. Gas pressure profile 600 shows how pressure varies within the pig terminal during the hydraulic emissions displacement operation, as described herein. Initially, as liquid 208 begins to fill the pig terminal, the pressure in the pig terminal is lower than the pipeline inlet, and no gas is forced back into pipeline 132. At a first point 602, the pig terminal pressure exceeds the pipeline inlet pressure, and gas flow into pipeline 132 from the pig terminal begins. After first point 602, the pig terminal pressure remains higher than the pipeline inlet pressure, as liquid 208 fills the pig terminal, and gas continues to be forced into pipeline 132 until a second point 604 is reached. At second point 604, the two pressures asymptotically approach the same value, and transfer of gas into pipeline 132 ceases, as liquid 208 completely fills the pig terminal.

Referring now to FIG. 7, an embedded controller 700 is shown. Embedded controller 700 can be used to control a pig terminal system, as disclosed herein. Specifically, embedded controller 700 can include a processor 702 having access to a memory 704, which can store firmware 706, representing instructions executable by processor 702. Firmware 706 can represent instructions and functionality executable by processor 702 for controlling pig terminal systems to perform the hydraulic emissions displacement operations disclosed herein. Also shown in embedded controller is communication interface(s) 708, which can represent any number and variety of communication interfaces for communicating with equipment included in pig terminal systems, as disclosed herein. For example, communication interface(s) 708 can include interfaces for controlling servo valves and obtaining measurement readings from sensors, such as pressure sensors and flow rate sensors. In this manner, firmware 706 can be developed to perform various hydraulic emissions displacement operations corresponding to the methods and systems disclosed herein.

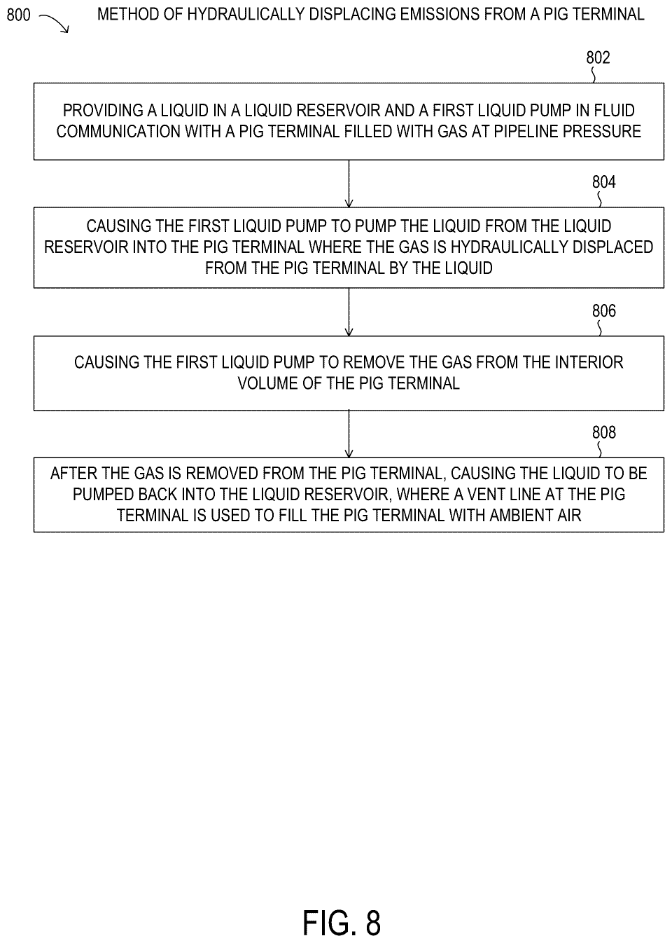

Referring now to FIG. 8, a flow chart of selected elements of an embodiment of method 800 for hydraulically displacing emissions from a pig terminal, as described herein, is depicted in flowchart form. Method 800 can be performed using embedded controller 700 by firmware 706, or can be performed manually by an operator, or various combinations thereof. It is noted that certain operations described in method 800 can be optional or can be rearranged in different embodiments.

method 800 can begin at, step 802, by providing a liquid in a liquid reservoir and a first liquid pump in fluid communication with a pig terminal filled with gas at pipeline pressure. At step 804, the first liquid pump causes pumping of the liquid from the liquid reservoir into the pig terminal where the gas is hydraulically displaced from the pig terminal by the liquid. At step 806, the first liquid pump causes the gas to be removed from the interior volume of the pig terminal. At step 808, after the gas is removed from the pig terminal, the liquid is caused to be pumped back into the liquid reservoir, where a vent line at the pig terminal is used to fill the pig terminal with ambient air.

The above disclosed subject matter is to be considered illustrative, and not restrictive, and the appended claims are intended to include all such modifications, enhancements, and other embodiments thereof which fall within the true spirit and scope of the present disclosure.

What is claimed is:

1. An apparatus for hydraulically displacing gas in gas pipelines, the apparatus comprising:
a liquid reservoir enabled to store a liquid and corresponding to an interior volume of a pig terminal, the pig terminal enabled for fluid communication with a gas pipeline;
a first liquid pump enabled for fluid communication with both the liquid reservoir and the pig terminal; and
a recovery line enabled for fluid communication with the pig terminal, wherein the recovery line is further enabled to remove a gas from the interior volume of the pig terminal in response to the first liquid pump causing the gas to be hydraulically displaced from the pig terminal by the liquid from the liquid reservoir.

2. The apparatus of claim 1, wherein the recovery line is further enabled for fluid communication with the gas pipeline and enabled to remove the gas into the gas pipeline.

3. The apparatus of claim 1, wherein the recovery line is further enabled for fluid communication with a collection reservoir and enabled to remove the gas into the collection reservoir.

4. The apparatus of claim 1, further comprising:
a second liquid pump enabled for fluid communication with both the liquid reservoir and the pig terminal and further enabled to remove the liquid from the pig terminal into the liquid reservoir.

5. The apparatus of claim 1, further comprising:
a pressure source enabled for fluid communication with the pig terminal and further enabled to displace the liquid from the pig terminal in response to pressurizing the pig terminal with air.

6. The apparatus of claim 5, wherein the pressure source is an air compressor.

7. The apparatus of claim 5, wherein the pressure source is a second pipeline.

8. The apparatus of claim 1, further comprising the pig terminal, and wherein the apparatus is located on a skid.

9. The apparatus of claim 1, wherein the apparatus is located on a vehicle.

10. The apparatus of claim 1, further comprising: a float actuator enabled for fluid communication with the recovery line, the float actuator further enabled to close the recovery line when the liquid enters the recovery line.

11. A method for hydraulic displacement, the method comprising:
using a liquid in a liquid reservoir corresponding to an interior volume of a pig terminal, the pig terminal enabled for fluid communication with a gas pipeline, causing a first liquid pump enabled for fluid communication with both the liquid reservoir and the pig terminal to remove a gas from the interior volume of the pig terminal in response to the first liquid pump causing the gas to be hydraulically displaced from the pig terminal by the liquid from the liquid reservoir,
wherein a recovery line enabled for fluid communication with the pig terminal is enabled to remove the gas from the pig terminal.

12. The method of claim 11, wherein the recovery line is further enabled for fluid communication with the gas pipeline, the method further comprising:
removing the gas into the gas pipeline using the recovery line.

13. The method of claim 11, wherein the recovery line is further enabled for fluid communication with a collection reservoir, the method further comprising:
removing the gas into the collection reservoir using the recovery line.

14. The method of claim 11, further comprising:
using a second liquid pump enabled for fluid communication with both the liquid reservoir and the pig terminal, removing the liquid from the pig terminal into the liquid reservoir.

15. The method of claim 11, further comprising:
using a pressure source enabled for fluid communication with the pig terminal, displacing the liquid from the pig terminal in response to pressurizing the pig terminal with air.

16. The method of claim 15, wherein the pressure source is an air compressor.

17. The method of claim 15, wherein the pressure source is a second gas pipeline.

18. The method of claim 11, further comprising:
using a float actuator enabled for fluid communication with the recovery line, closing the recovery line when the liquid enters the recovery line.

19. The method of claim 11, further comprising:
monitoring a first pressure of the liquid displacing the gas in the pig terminal;
monitoring a second pressure of the gas displaced by the liquid; and
monitoring a flow rate of the liquid.

20. The method of claim 19, further comprising:
detecting a leak of the liquid from the pig terminal based on at least one of: the first pressure, the second pressure, and the flow rate.

21. A controller for hydraulic displacement, the controller comprising:
a processor enabled to access memory media storing instructions executable by the processor; and
an input/output communications interface accessible to the processor and enabled to communicate with sensors and actuators and further enabled to provide a user interface for outputting information to and receiving commands from a user,
wherein the instructions are executable by the processor for:
using a liquid in a liquid reservoir corresponding to an interior volume of a pig terminal, the pig terminal enabled for fluid communication with a gas pipeline, causing a first liquid pump enabled for fluid communication with both the liquid reservoir and the pig terminal to remove a gas from the interior volume of the pig terminal in response to the first liquid pump causing the gas to be hydraulically displaced from the pig terminal by the liquid from the liquid reservoir,
wherein a recovery line enabled for fluid communication with the pig terminal is enabled to remove the gas from the pig terminal.

22. The controller of claim 21, wherein the memory media stores first data indicating that the recovery line is further enabled for fluid communication with the gas pipeline, and wherein the gas is removed into the gas pipeline using the recovery line.

23. The controller of claim 21, wherein the memory media stores second data indicating that the recovery line is further enabled for fluid communication with a collection reservoir, and wherein the gas is removed into the collection reservoir using the recovery line.

24. The controller of claim 21, further comprising instructions executable by the processor for:
causing a second liquid pump enabled for fluid communication with both the liquid reservoir and the pig terminal to remove the liquid from the pig terminal into the liquid reservoir.

25. The controller of claim 21, further comprising instructions executable by the processor for:
causing a pressure source enabled for fluid communication with the pig terminal to displace the liquid from the pig terminal in response to pressurizing the pig terminal with air.

26. The controller of claim 25, wherein the pressure source is an air compressor.

27. The controller of claim 25, wherein the pressure source is a second gas pipeline.

28. The controller of claim 21, further comprising instructions executable by the processor for:
causing a float actuator enabled for fluid communication with the recovery line to close the recovery line when liquid enters the recovery line.

29. The controller of claim 21, further comprising instructions executable by the processor for at least one of:
monitoring a first pressure of the liquid displacing the gas in the pig terminal;
monitoring a second pressure of the gas displaced by the liquid; and
monitoring a flow rate of the liquid.

30. The controller of claim 28, further comprising instructions executable by the processor for:
detecting a leak of the liquid from the pig terminal based on at least one of: the first pressure, the second pressure, and the flow rate.

31. The controller of claim 28, further comprising instructions executable by the processor for at least one of:
detecting that the pig terminal is isolated from the gas pipeline;
detecting that the pig terminal is filled with the gas at the high pressure;
detecting whether a pig is present in the pig terminal;
outputting a first indication that the pig terminal can be opened;
outputting a second indication indicating presence or absence of the pig in the pig terminal; and
detecting an over pressure condition associated with the pig terminal.
